(19) United States
(12) Patent Application Publication
(10) Pub. No.: US 2003/0108166 A1
(43) Pub. Date: Jun. 12, 2003

(54) Integrated voice mail display system

(76) Inventors: Cliff L. Coppinger, Boise, ID (US); Kram H. Allen, Meridian, ID (US); Linn J. Kropf, Bosie, ID (US)

Correspondence Address: HEWLETT-PACKARD COMPANY, Intellectual Property Administration, P.O. Box 272400, Fort Collins, CO, 80527-2400, US

(21) Appl. No.: 10/011,136

(22) Filed: Dec. 7, 2001

(51) Int. Cl. H04M 1/64

(52) U.S. Cl. 379/88.11

(57) ABSTRACT

An integrated voice mail system associates the ID of the sender of a voice mail with the voice mail. Also associated are IDs for the other recipients of the voice mail, as well as previous senders. These IDs are utilized as keys to retrieve identification information associated with those IDs. The identification information for the sender of a voice mail, as well as for other recipients and previous senders, is selectively displayed upon an enlarged telephone display for the recipient of the voice mail.

### FIELD OF THE INVENTION

The present invention generally relates to telephone systems and, more specifically, to a voice messaging telephone system.

### BACKGROUND OF THE INVENTION

In the early days of telephones, operators were utilized to manually route calls. Later, the telephone companies discovered how to electromechanically route telephone calls without the use of operators in most cases. The result was the installation of giant telephone switches across the country. It was inevitable that these switches would become more and more controlled by computers. In a similar way, businesses moved from operator-routed calls through electromechanically routed calls to switches controlled totally by computers.

One of the fall-outs of utilizing computers to perform routing was that the source of an incoming telephone call could be provided to the recipient, who, for example, could then either accept or decline receipt of that incoming telephone call. One name utilized for this service is “caller-id”.

Voice calls were traditionally analog communications. Answering machines were developed to save the contents of telephone calls for later replay. For a number of years, telephone answering machines recorded messages in an analog format. Indeed, these earlier answering machines were little different than tape recorders.

At some point, it was discovered that voice messages could be digitized. This ultimately led to voice mail, where callers leave a digitized voice message stored typically these days on some digital medium such as disk. Then later, the recipient of the voice mail listens to his messages converted back to analog. Except for converting analog voice to digital format when entering a telephone system and then converting back to analog when leaving the telephone system, modem Private Branch Exchange (PBX) (and the like) telephone systems are almost totally constructed utilizing digital components—little different than are used in computer systems. This has had numerous advantages, including price, reliability, and flexibility.

Voice mail has become ubiquitous throughout the business world. Very few medium to large sized businesses today in the United States do not utilize some sort of electronic telephone switch that supports some form of voice mail. Voice mail has, for example, aided the globalization of the economy through the ability to time shift verbal communications. It is also extremely helpful when verbal communications can be efficiently performed in situations that do not require verbal interaction, but rather the dropping off of information.

Unfortunately, the paradigm currently in existence with voice mail of dropping off information, and receiving a response later, does not work optimally. In particular, it presumes a one-to-one mapping of senders and recipients.

To partially overcome these problems, many voice mail systems allow recipients of voice mail to forward received messages to other users of the systems. Also available in some voice mail systems is the ability to deliver a voice mail message to multiple recipients. Multiple-person conversations and voice mail distributions are now commonplace in many businesses.

However, these new uses of voice mail are not as useful as they could be. One part of the problem is that phone mail users quickly become lost as to who said what to whom and when. One important part of this is that those involved in these conversations often do not know who has heard what and when it was heard. These and other problems will become more evident hereinbelow.

### SUMMARY OF THE INVENTION

An integrated voice mail system associates the ID of the sender of a voice mail with the voice mail. Also associated are IDs for the other recipients of the voice mail, as well as previous senders. These IDs are utilized as keys to retrieve identification information associated with those IDs. The identification information for the sender of a voice mail, as well as for other recipients and previous senders, is selectively displayed upon an enlarged telephone display for the recipient of the voice mail.

### DESCRIPTION OF THE DRAWINGS

The features and advantages of the present invention will be more clearly understood from the following detailed description taken in conjunction with the accompanying FIGURES where like numerals refer to like and corresponding parts and in which:

FIG. 1 is a block diagram illustrating an exemplary telephone system, in accordance with a preferred embodiment of the present invention;

FIG. 2 is a block diagram illustrating a telephone as shown in FIG. 1; and

FIG. 3 is a block diagram illustrating an exemplary General Purpose Computer as used for a central control system as shown in FIG. 1.

### DETAILED DESCRIPTION OF THE INVENTION

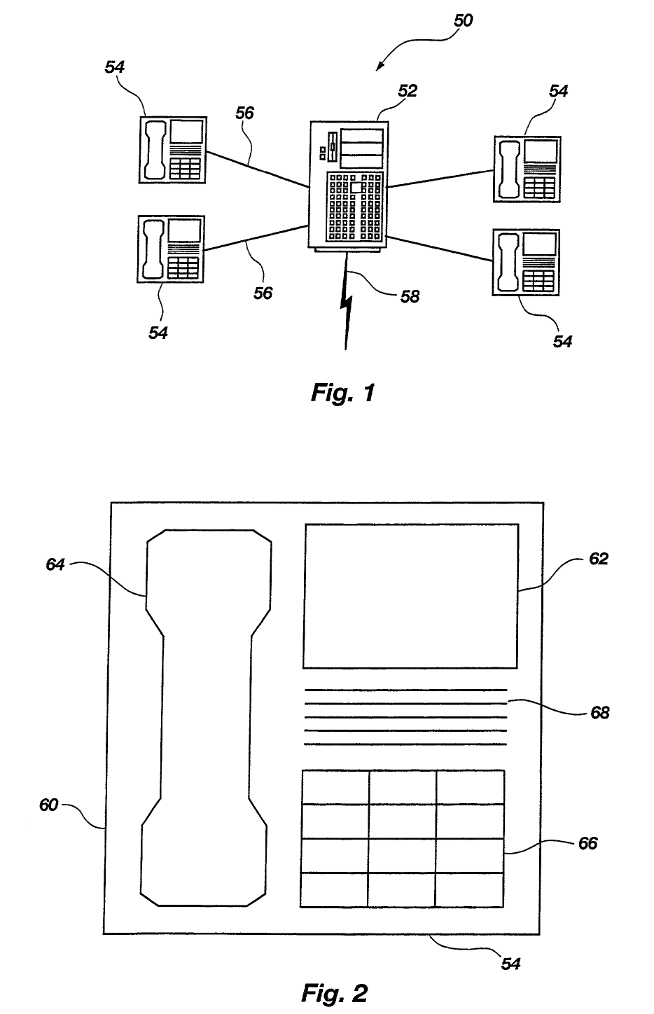

FIG. 1 is a block diagram illustrating an exemplary telephone system 50, in accordance with a preferred embodiment of the present invention. The telephone system 50 includes a central control system 52, shown here as a server computer system, and a plurality of telephones 54 electronically coupled 56 to the central control system 52. In a typical telephone system 50, the telephones 54 and the central control system 52 communicate digitally. Voice (and other sounds) are converted from analog to digital format at the telephone 54 and transmitted to the central control system 52. Similarly, voice (and other sounds) are converted from digital back to analog format again at the telephones.

The central control system 52 is also coupled to other, larger telephone systems (not shown), with one or more communications links 58. These larger telephone systems are often owned by telephone companies that provide telephone services to many end-users and businesses. Currently, the typical central control system 52 will translate from digital to analog format for all telephone calls leaving the telephone system 50 and from analog to digital format for all incoming telephone calls entering the telephone system. However, this is not necessary if a user of this telephone system 50 is communicating with a user on another telephone system that also utilizes digital messaging. Indeed, it is expected that the percentage of totally digital voice communications will continue to rise throughout the foreseeable future since digital communications provide significant improvements over analog communications, including improvements in reliability and storage requirements.

The telephones in the telephone system shown in FIG. 1 preferably include a display screen of some type. For example, the telephones may include LCD or LED screens. These display screens have become common in the prior art, typically providing one or two lines of information to a telephone user. However, the telephones in the preferred embodiment include larger display screens that provide room for additional information.

FIG. 2 is a block diagram illustrating a telephone as shown in FIG. 1. The telephone 54 has a base 60, a handset 62, a display screen 64, a set of keys 66, including a keypad, and a speaker 68. As noted above, the display screen 64 is larger than is typical in the prior art, preferably being large enough to contain a half dozen or so lines of text.

In the prior art, such display screens often provided the identity of an incoming caller. This information is also often saved in a stack of the most recent callers. However, the identity of a voice mail sender has typically not been provided in the past—except possibly in a caller-id stack.

In the present invention, each voice mail message has an associated sender. At a lower level, this is typically the ID of the telephone leaving the voice mail. However, in the preferred embodiment, this ID is utilized as a database key, and the name (and potentially other identifying information) is retrieved and displayed to a voice mail recipient utilizing this key. Note that the ID saved may alternatively be telephone company supplied caller-id information for calls originating outside the telephone system 50.

In addition, the telephone paradigm has been extended to be similar to that utilized for email. Thus, in the preferred embodiment, in addition to the sender of a voice mail, an ID for each of the other recipients of the voice mail is associated and saved with the voice mail message, as well as the ID of each of the previous senders of such. These IDs are recorded and the names associated with these IDs are displayed upon request at the telephones of voice mail recipients. Thus, a voice mail recipient has available to him the distribution list and the Carbon Copy (CC) list of all recipients of this voice mail, as well as the list of all previous senders of this voice mail, and the distribution and CC lists for those copies as well. The voice mail user can scroll through these lists in order to determine who received what portions of a voice mail. As with email, in the preferred embodiment, some of the recipients of a voice mail can also be designated as Blind Carbon Copy (BCC) recipients. These recipients would not appear as recipients of the voice mail message to anyone except the sender to them. Another feature of the present invention is to reply to all, or a specified subset, of the recipients of a voice mail.

One major advantage of this invention is that by providing these email-type capabilities to voice mail users, combined with the present ability to forward email to one or more people, voice mail can be utilized to provide efficient voice communications that are not time constrained by the necessity that all participants in the conversation be present at any specific time. This is especially helpful when participants live in different parts of the world and thus in widely separated time zones. By providing in an easily usable format the information as to who has heard what, users of such a voice mail system can eliminate having to send a voice mail message to people who have already received it.

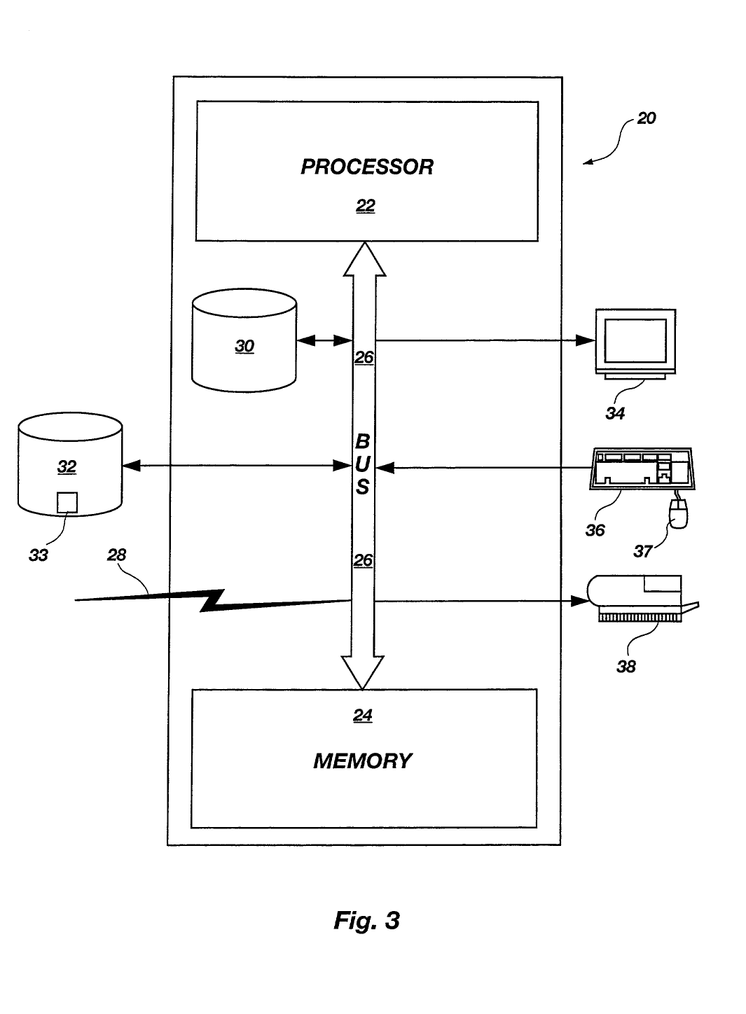

FIG. 3 is a block diagram illustrating an exemplary General Purpose Computer 20 as used for a central control system 52 as shown in FIG. 1. The General Purpose Computer 20 has a Computer Processor 22 and Memory 24, connected by a Bus 26. Memory 24 is a relatively high-speed, machine-readable medium and includes Volatile Memories, such as DRAM and SRAM, and Non-Volatile Memories, such as ROM, FLASH, EPROM, and EEPROM. Also connected to the Bus 26 are Secondary Storage 30, External Storage 32, output devices such as a monitor 34, input devices such as a keyboard 36 (with mouse 37), and printers 38. Secondary Storage 30 includes machine-readable media such as hard disk drives (or DASD) and disk subsystems. External Storage 32 includes machine-readable media such as floppy disks, removable hard drives, magnetic tapes, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such as voice mail software and computer readable instructions can be stored in a Computer Readable Medium, such as Memory 24, Secondary Storage 30, and External Storage 32. Executable versions of computer software 33 can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

The above system is illustrative only. Other embodiments are also within the scope of this invention. Voice mail, the associated IDs, and the names database associated with these IDs are typically stored in Non-Volatile Memory.

Those skilled in the art will recognize that modifications and variations can be made without departing from the spirit of the invention. Therefore, it is intended that this invention encompass all such variations and modifications as fall within the scope of the appended claims.

Claim elements and steps herein have been numbered and/or lettered solely as an aid in readability and understanding. As such, the numbering and/or lettering in itself is not intended to, and should not be taken to, indicate the ordering of elements and/or steps in the claims.

What is claimed is:

1. A method of delivering voice mail messages, comprising:
receiving a voice mail message for a first set of recipients from a first sender of the voice mail message;
routing the voice mail message to each of the first set of recipients; and
displaying identification information for the first set of recipients to a first recipient within the first set of recipients.

2. The method in claim 1 which further comprises:
associating a first set of IDs with the first set of recipients, wherein each of the first set of IDs is associated with one of the first set of recipients.

3. The method in claim 2 wherein:
the method further comprises:
retrieving an identification record from a database utilizing one of the first set of IDs as a database key; and
the displaying information in the identification record retrieved.

4. The method in claim 1 which further comprises:
displaying identification information for the first sender to the first recipient.

5. The method in claim 4 which further comprises:
displaying identification information for a second sender of the voice mail message to the first recipient.

6. The method in claim 1 which further comprises:
routing the voice mail message to each of a second set of recipients; and
displaying identification information for the second set of recipients to the first recipient.

7. The method in claim 6 wherein:
the first set of recipients is a set of designated recipients; and
the second set of recipients is a set of carbon copied recipients.

8. The method in claim 6 wherein:
the first set of recipients is a set of designated recipients; and
the second set of recipients is a set of designated recipients of a previous copy of the voice mail message.

9. The method in claim 4 wherein:
said method further comprises:
routing the voice mail message to each of a second set of recipients; and
suppressing the displaying of identification information for the second set of recipients to the first recipient; and
the first set of recipients is a list of designated recipients; and
the second set of recipients is a list of blind carbon copied recipients.

10. A computer readable medium having computer readable instructions thereon for:
receiving a voice mail message for a first set of recipients from a first sender of the voice mail message;
routing the voice mail message to each of the first set of recipients; and
displaying identification information for the first set of recipients to a first recipient within the first set of recipients.

11. A voice mail system for delivering voice mail messages, comprising:
a means for receiving a voice mail message for a first set of recipients from a first sender of the voice mail message;
a means for routing the voice mail message to each of the first set of recipients; and
a means for displaying identification information for the first set of recipients to a first recipient within the first set of recipients.

12. The voice mail system in claim 11 which further comprises:
a means for associating a first set of IDs with the first set of recipients, wherein each of the first set of IDs is associated with one of the first set of recipients.

13. The voice mail system in claim 12 wherein:
the voice mail system further comprises:
a means for retrieving an identification record from a database utilizing one of the first set of IDs as a database key; and
the displaying information in the identification record retrieved.

14. The voice mail system in claim 11 which further comprises:
a means for displaying identification information for the first sender to the first recipient.

15. The voice mail system in claim 14 which further comprises:
a means for displaying identification information for a second sender of the voice mail message to the first recipient.

16. The voice mail system in claim 11 which further comprises:
a means for routing the voice mail message to each of a second set of recipients; and
a means for displaying identification information for the second set of recipients to the first recipient.

17. The voice mail system in claim 16 wherein:
the first set of recipients is a set of designated recipients; and
the second set of recipients is a set of carbon copied recipients.

18. The voice mail system in claim 16 wherein:
the first set of recipients is a set of designated recipients; and
the second set of recipients is a set of designated recipients of a previous copy of the voice mail message.

19. The voice mail system in claim 14 wherein:
said voice mail system further comprises:
a means for routing the voice mail message to each of a second set of recipients; and
suppressing the displaying of identification information for the second set of recipients to the first recipient;
the first set of recipients is a list of designated recipients; and
the second set of recipients is a list of blind carbon copied recipients.

20. The voice mail system in claim 11 wherein:
the means for displaying comprises:
a telephone screen in a telephone that supports a display of at least a half-dozen lines of text on the telephone screen.
